(19) United States
(12) Patent Application Publication
(10) Pub. No.: US 2026/0112560 A1
(43) Pub. Date: Apr. 23, 2026

(54) DIRECT CURRENT RELAY WITH AUXILIARY CONTACT

(71) Applicant: Kunshan GLVAC YuanTong New Energy Technology Co., Ltd., Suzhou (CN)

(72) Inventors: Chunpeng GU, Suzhou (CN); Tianjie LIU, Suzhou (CN); Jifan YANG, Suzhou (CN)

(73) Assignee: Kunshan GLVAC YuanTong New Energy Technology Co., Ltd., Suzhou (CN)

(21) Appl. No.: 19/314,165

(22) Filed: Aug. 29, 2025

Related U.S. Application Data
(63) Continuation of application No. PCT/CN2025/071309, filed on Jan. 8, 2025.

(30) Foreign Application Priority Data
Sep. 25, 2024 (CN) 202422342069.4

(51) Int. Cl. H01H 50/54; H01H 50/04; H01H 50/64; H01H 50/74

(52) U.S. Cl. CPC H01H 50/541; H01H 50/042; H01H 50/641; H01H 50/74

(57) ABSTRACT

A Direct Current (DC) relay with an auxiliary contact includes a fixed contact, a movable contact plate, an auxiliary fixed contact, an auxiliary movable contact plate and a pushing rod assembly. The pushing rod assembly is configured to drive the movable contact plate to make or break contact with the fixed contact, and simultaneously drive the auxiliary movable contact plate to make or break contact with the auxiliary fixed contact; wherein the pushing rod assembly includes an insulating base, the auxiliary movable contact plate is fixedly disposed at a bottom of the insulating base, and the auxiliary movable contact plate is provided with a force arm extension portion located at the bottom of the insulating base and an auxiliary contact leg extending outward from the insulating base and arranged opposite to the auxiliary fixed contact.

### CROSS-REFERENCE TO RELATED APPLICATIONS

This application is a continuation of International Application No. PCT/CN2025/071309, filed on Jan. 8, 2025, which claims priority to Chinese Patent Application No. 202422342069.4, filed on Sep. 25, 2024. All of the aforementioned applications are incorporated herein by reference in their entireties.

### TECHNICAL FIELD

The present disclosure relates to the technical field of relays, specifically to a Direct Current (DC) relay with an auxiliary contact.

### BACKGROUND

With rapid development of the new energy industry, market demands for functional integration and diversification of high-voltage DC relays continue to increase. While the main circuit is normally open or closed, an auxiliary circuit is required to monitor the main circuit status or provide additional switching operations for independent disconnection and closure, thereby achieving auxiliary circuit disconnection and conduction. Under these circumstances, DC relays with auxiliary contacts have emerged. The auxiliary contacts serve as auxiliary logic switches in the circuit control system to determine the operating state of the relay and monitor adhesion failure conditions in the main circuit contacts.

For example, Chinese Patent Application Publication No. CN117577486A (published Feb. 20, 2024) discloses a high-voltage DC relay with auxiliary contacts. The high-voltage DC relay with auxiliary contacts provides a connecting member on a pushing assembly, where the connecting member moves with the pushing assembly to contact a first auxiliary contact leading-out terminal and a second auxiliary contact leading-out terminal, achieving electrical conduction between the first auxiliary contact leading-out terminal and the second auxiliary contact leading-out terminal. The connecting member is a copper sheet, and at least part of the pushing assembly is plastic. The copper sheet and the plastic are integrally formed by insert molding. Although this conventional auxiliary contact structure can monitor the working state of the main contacts, its design still has certain defects: a part of the connecting member is embedded in the pushing assembly through molding, while another part extends upward from the pushing assembly to contact the auxiliary contact leading-out terminals. This configuration results in a short force arm of the connecting member. During the relay operation, the connecting member must withstand significant torque, making the connecting member prone to material yielding or even fracture. Should this occur, even when the auxiliary contacts are closed, effective conduction cannot be achieved, thereby affecting normal operation of the relay. Therefore, within limited internal space of DC relays, how to provide an auxiliary contact structure with increased force arm length has become a technical problem urgently requiring resolution by those skilled in the art.

### SUMMARY

The technical problem addressed by the present disclosure is to provide a DC relay with an auxiliary contact, overcoming conventional defects in existing DC relays where relatively short auxiliary contact force arms are prone to causing material yielding or even fracture.

To resolve this technical problem, the present disclosure adopts the following technical solution: A DC relay with an auxiliary contact, comprising a fixed contact, a movable contact plate, an auxiliary fixed contact, an auxiliary movable contact plate and a pushing rod assembly; wherein the pushing rod assembly is configured to drive the movable contact plate to make or break contact with the fixed contact, and simultaneously drive the auxiliary movable contact plate to make or break contact with the auxiliary fixed contact; wherein the pushing rod assembly comprises an insulating base, the auxiliary movable contact plate is fixedly disposed at a bottom of the insulating base, and the auxiliary movable contact plate is provided with a force arm extension portion located at the bottom of the insulating base and an auxiliary contact leg extending outward from the insulating base and arranged opposite to the auxiliary fixed contact; and wherein the force arm extension portion and the auxiliary contact leg are integrally connected to form an auxiliary movable contact arm.

As a further improvement of the present disclosure, an end of the force arm extension portion away from the auxiliary contact leg is fixedly connected to the insulating base to form a fixed point; the auxiliary contact leg is provided with a contact point configured to abut against the auxiliary fixed contact; and the force arm length of the auxiliary movable contact arm is a vertical distance from the contact point to the fixed point.

As a further improvement of the present disclosure, the auxiliary movable contact plate is made of an elastic conductive metal material; and when the movable contact plate makes contact with the fixed contact, the auxiliary fixed contact abuts against the auxiliary contact leg such that the auxiliary movable contact arm undergoes elastic deformation.

As a further improvement of the present disclosure, two auxiliary contact legs are provided, and the two auxiliary contact legs extend symmetrically outward from opposite sides of the insulating base.

As a further improvement of the present disclosure, the bottom of the insulating base is provided with a support boss; a central portion of the auxiliary movable contact plate is provided with a hole configured to sleeve onto the support boss, forming two force arm extension portions arranged in a herringbone shape and symmetrically distributed; each of the two force arm extension portions is connected to a respective one of the two auxiliary contact legs; and each of the force arm extension portions comprises two ends away from the respective one of the auxiliary contact legs, and each end is provided with a fixed point.

As a further improvement of the present disclosure, two auxiliary contact legs are provided, and the two auxiliary contact legs extend outward from the same side of the insulating base side by side.

As a further improvement of the present disclosure, the insulating base is integrally formed by injection molding of a plastic material; and the insulating base and the force arm extension portion are directly and fixedly connected at the fixed point by any one of riveting, bonding, screw fastening and insert molding.

As a further improvement of the present disclosure, the insulating base is integrally formed by injection molding of a plastic material; a heat staking post is further integrally formed on the bottom of the insulating base; one end of the force arm extension portion is provided with an insertion hole; and the heat staking post is inserted into the insertion hole and fixed via a heat staking riveting process to form the fixed point.

As a further improvement of the present disclosure, one end of the auxiliary contact leg is provided with a horizontally distributed contact tongue; and another end of the auxiliary contact leg is bent downward relative to the contact tongue and connected to the force arm extension portion, such that the contact tongue is at a height greater than the force arm extension portion.

The beneficial effects of the present disclosure are as follows: The present disclosure provides a DC relay with an auxiliary contact, wherein the auxiliary movable contact plate is fixedly disposed at a bottom of the insulating base, and the auxiliary movable contact plate is provided with a force arm extension portion located at the bottom of the insulating base and an auxiliary contact leg extending outward from the insulating base and arranged opposite to the auxiliary fixed contact; and wherein the force arm extension portion and the auxiliary contact leg are integrally connected to form an auxiliary movable contact arm. Within limited internal space of the relay, this structure rationally utilizes space at the bottom of the insulating base, maximizing the force arm length of the auxiliary movable contact plate. This effectively resolves risks of material yielding or fracture caused by short force arms during operation that may result in non-conduction after auxiliary contact closure, thereby guaranteeing normal operation of the relay.

### BRIEF DESCRIPTION OF THE DRAWINGS

FIG. 1 is a perspective view of Embodiment 1 of the DC relay with the auxiliary contact according to the present disclosure.

FIG. 2 is a cross-sectional view of Embodiment 1 of the DC relay with the auxiliary contact according to the present disclosure.

FIG. 3 is a right-side view of the movable contact plate, the auxiliary fixed contact, the auxiliary movable contact plate, and the pushing rod assembly in Embodiment 1 of the present disclosure.

FIG. 4 is a perspective view of the movable contact plate, the auxiliary movable contact plate, and the pushing rod assembly in Embodiment 1 of the present disclosure.

FIG. 5 is an exploded view of the auxiliary movable contact plate and the insulating base in Embodiment 1 of the present disclosure.

FIG. 6 is a perspective view of the auxiliary movable contact plate in Embodiment 1 of the present disclosure.

FIG. 7 is a perspective view of Embodiment 2 of the DC relay with the auxiliary contact according to the present disclosure.

FIG. 8 is a bottom view of the auxiliary movable contact plate and the insulating base in Embodiment 2 of the present disclosure.

### DETAILED DESCRIPTION OF THE EMBODIMENTS

The following describes preferred embodiments of the present disclosure in detail with reference to the drawings.

### Embodiment 1

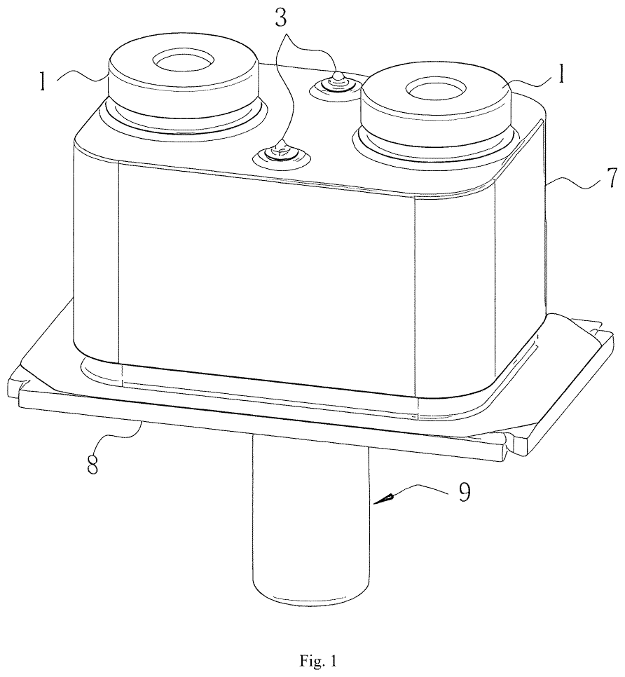

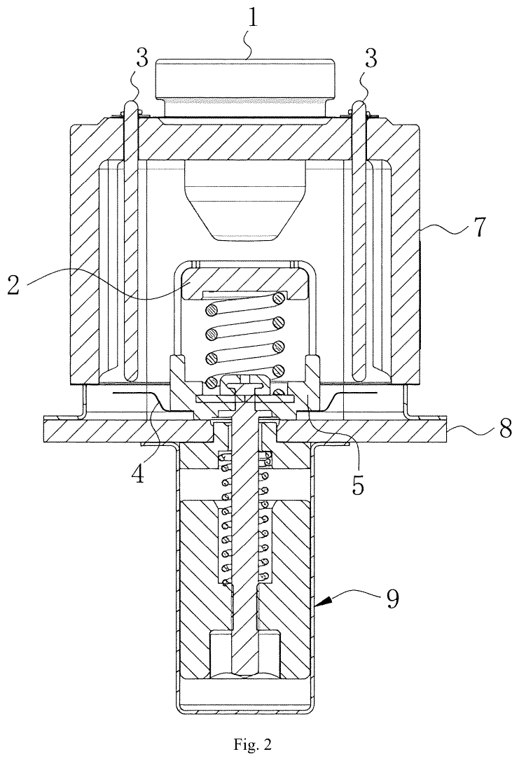

Referring to FIGS. 1 and 2, the present disclosure provides a DC relay with an auxiliary contact, comprising: an auxiliary fixed contact 3, an auxiliary movable contact plate 4, and conventional prior-art components including: a fixed contact 1, a movable contact plate 2, a pushing rod assembly, a ceramic cover 7, a magnetic pole piece 8, and an electromagnetic drive mechanism 9.

The ceramic cover 7 is fixed to the top of the magnetic pole piece 8 via a connecting ring. The fixed contact 1 generally comprises a pair, namely two fixed contacts. The two fixed contacts 1 are fixed side by side on the top of the ceramic cover 7. The lower end of each of the two fixed contacts 1 extends into the inner portion of the ceramic cover 7, and the upper end of each of the two fixed contacts 1 protrudes upward beyond the ceramic cover 7 and is configured for connection to a load circuit. A pushing rod assembly is housed within the ceramic cover 7. A movable contact plate 2 is mounted on the pushing rod assembly, and both ends of the movable contact plate 2 are positioned directly below the two fixed contacts 1. An electromagnetic drive mechanism 9 is disposed at the bottom of the magnetic pole piece 8 and connected to the pushing rod assembly. The electromagnetic drive mechanism 9 is configured to drive the pushing rod assembly to move axially upward and downward, thereby driving the movable contact plate 2 via the pushing rod assembly to make or break contact with the two fixed contacts 1.

In this embodiment, an auxiliary fixed contact 3 is also fixed to the ceramic cover 7. An auxiliary movable contact plate 4 is fixed to the pushing rod assembly. While the pushing rod assembly drives the movable contact plate 2 to make or break contact with the two fixed contacts 1, the pushing rod assembly is also capable of driving the auxiliary movable contact plate 4 to make or break contact with the auxiliary fixed contact 3, so as to monitor the operating state of the relay.

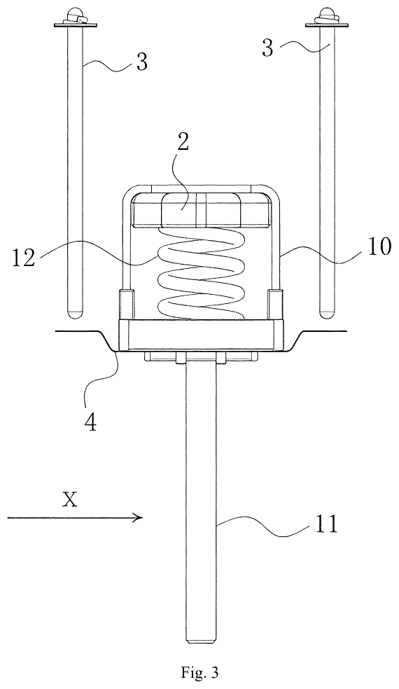

Referring to FIG. 3 to FIG. 5, the pushing rod assembly comprises an insulating base 5, the auxiliary movable contact plate 4 is fixedly disposed at a bottom of the insulating base 5, and the auxiliary movable contact plate 4 is provided with a force arm extension portion 41 located at the bottom of the insulating base 5 and an auxiliary contact leg 42 extending outward from the insulating base 5 and arranged opposite to the auxiliary fixed contact 3 in an up-down direction. The force arm extension portion 41 and the auxiliary contact leg 42 are integrally connected and together form an auxiliary movable contact arm 43. This structure ensures that the force arm of the auxiliary movable contact plate 4 is not limited only to the portion outside the insulating base 5, but also includes the portion located at the bottom of the insulating base 5, i.e. the force arm extension portion 41. Within limited internal space of the relay, this structure rationally utilizes space at the bottom of the insulating base 5, maximizing the force arm length of the auxiliary movable contact plate 4. This effectively resolves risks of material yielding or fracture caused by short force arms during operation that may result in non-conduction after auxiliary contact closure, thereby guaranteeing normal operation of the relay.

The auxiliary movable contact plate 4 is integrally formed from an elastic conductive metal material. When the electromagnetic drive mechanism 9 drives the pushing rod assembly to move upward, thereby pushing the movable contact plate 2 to make contact with the fixed contact 1, the pushing rod assembly simultaneously drives the auxiliary movable contact plate 4 to move upward, causing the auxiliary fixed contact 3 to abut against the auxiliary contact leg 42. Since the movement stroke of the auxiliary movable contact plate 4 driven by the pushing rod assembly is larger than the spacing between the auxiliary movable contact plate 4 and the auxiliary fixed contact 3 in the open state, the abutment by the auxiliary fixed contact 3 causes the auxiliary movable contact arm 43 to undergo a certain amount of elastic deformation. This elastic deformation ensures reliable contact between the auxiliary fixed contact 3 and the auxiliary movable contact plate 4. Concurrently, because the auxiliary movable contact arm 43 has a longer force arm, the auxiliary movable contact arm 43 is capable of withstanding a relatively large torque and is not prone to the risk of material yielding or fracture.

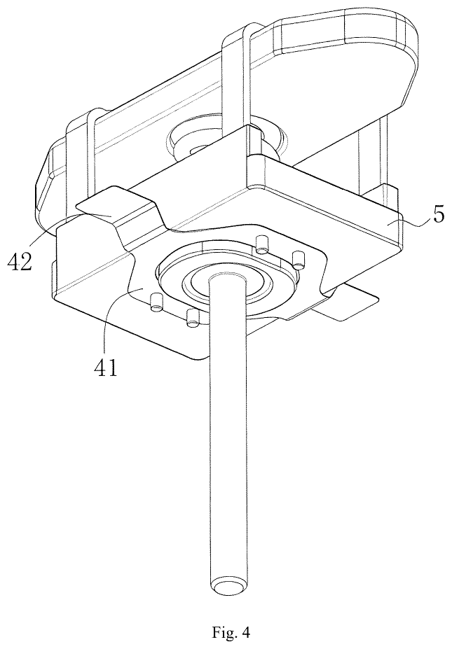

As shown in FIG. 4, an end of the force arm extension portion 41 away from the auxiliary contact leg 42 is fixedly connected to the insulating base 5 to form a fixed point; the auxiliary contact leg 42 is provided with a contact point configured to abut against the auxiliary fixed contact 3; and the force arm length of the auxiliary movable contact arm 43 is a vertical distance from the contact point to the fixed point. It is to be understood that the aforementioned “vertical distance” does not refer to a straight-line distance between the contact point and the fixed point, but rather refers to a distance along the X-axis direction with reference to FIG. 3.

In this embodiment, two auxiliary fixed contacts 3 are provided. The two auxiliary fixed contacts 3 are distributed on opposite sides of the pushing rod assembly and are each fixedly disposed along a vertical direction on a top wall of the ceramic cover 7. Correspondingly, two auxiliary contact legs 42 are also provided. The two auxiliary contact legs 42 extend symmetrically outward from opposite sides of the insulating base 5.

Certainly, in other embodiments of the present disclosure, the two auxiliary fixed contacts 3 may also each be fixedly disposed along a horizontal direction on opposite side walls of the ceramic cover 7, and can similarly achieve making or breaking contact with the two auxiliary contact legs 42.

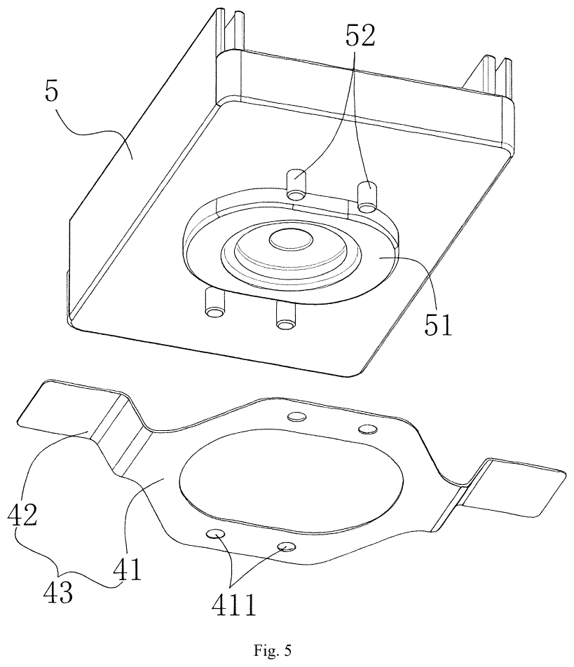

Referring to FIG. 2 and FIG. 5, the bottom of the insulating base 5 is provided with a support boss 51. The support boss 51 is configured to support on the magnetic pole piece 8 when the relay is in a de-energized state.

Referring to FIG. 4 to FIG. 6, a central portion of the auxiliary movable contact plate 4 is provided with a hole in an annular shape, configured to sleeve onto the support boss 51. The annular central portion of the auxiliary movable contact plate 4 can be regarded as being integrally formed by two force arm extension portions 41 distributed symmetrically in a herringbone shape. Each of the two auxiliary contact legs 42 is connected to a respective one of the two force arm extension portions 41. Each of the force arm extension portions 41 comprises two ends away from the respective one of the auxiliary contact legs 42, and each end is provided with a fixed point. The force arm length of the auxiliary movable contact arm 43 is a vertical distance from the contact point to a line connecting the two fixed points.

In the present disclosure, the insulating base 5 is integrally formed by injection molding of a plastic material. Furthermore, the bottom of the insulating base 5 is integrally formed with four heat staking posts 52 corresponding to positions of the fixed points. Two end portions of each force arm extension portion 41 away from the auxiliary contact leg 42 are each provided with an insertion hole 411 corresponding to the position of a fixed point. The heat staking posts 52 are inserted one-to-one into the insertion holes 411 and are fixed via a heat staking riveting process to form the fixed points.

Certainly, in other embodiments of the present disclosure, the insulating base 5 and the force arm extension portion 41 may also be directly and fixedly connected at the fixed point by any one of riveting, bonding, screw fastening and insert molding.

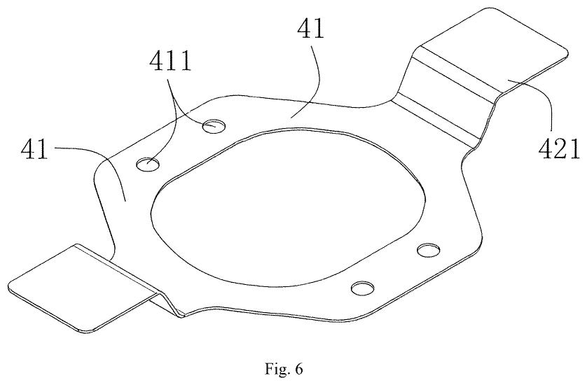

Referring to FIG. 3 and FIG. 6, one end of the auxiliary contact leg 42 is provided with a horizontally distributed contact tongue 421; and another end of the auxiliary contact leg 42 is bent downward relative to the contact tongue 421 and connected to the force arm extension portion 41, such that the contact tongue 421 is at a height greater than the force arm extension portion 41.

In this embodiment, the pushing rod assembly further comprises a contact holder 10, a push rod 11, and a contact spring 12. The contact holder 10 is frame-shaped. A bottom of the contact holder 10 and an upper end of the push rod 11 are integrally insert-molded within the insulating base 5 and are mutually insulated. A lower end of the push rod 11 extends vertically downward after passing through the magnetic pole piece 8. The movable contact plate 2 traverses the contact holder 10. The contact spring 12 is arranged between the insulating base 5 and the movable contact plate 2. The contact spring 12 applies an upward elastic force to the movable contact plate 2, causing the movable contact plate 2 to abut against a top wall of the contact holder 10.

In this embodiment, the electromagnetic drive mechanism 9 comprises a movable iron core, a stationary iron core, a U-shaped yoke, a coil winding, and the like, wherein the U-shaped yoke and the coil winding are not shown in the figures. The stationary iron core is fixed at a bottom of the magnetic pole piece 8. The movable iron core is spaced apart opposite to and below the stationary iron core and is fixedly connected to the lower end of the push rod 11. A bottom of the magnetic pole piece 8 is also fixedly provided with a sleeve. Both the stationary iron core and the movable iron core are housed within the sleeve. A return spring is mounted between the stationary iron core and the movable iron core. The coil winding is sleeved on an outer side of the sleeve.

When the coil winding is energized, the magnetized movable iron core is attracted by the stationary iron core and moves upward, ultimately adhering to the bottom of the stationary iron core. During this process, the movable iron core pushes the movable contact plate 2 upward via the pushing rod assembly, causing the movable contact plate 2 to contact and conduct electricity with the two fixed contacts 1. Simultaneously, the pushing rod assembly drives the auxiliary movable contact plate 4 upward, causing the auxiliary movable contact plate 4 to make contact with the two auxiliary fixed contacts 3. When the coil winding is de-energized, the magnetic attractive force between the movable iron core and the stationary iron core disappears. Under the combined action of the contact spring 12 and the return spring, the movable iron core moves downward to reset, causing the movable contact plate 2 to break contact with the two fixed contacts 1, and simultaneously causing the auxiliary movable contact plate 4 to break contact with the two auxiliary fixed contacts 3.

### Embodiment 2

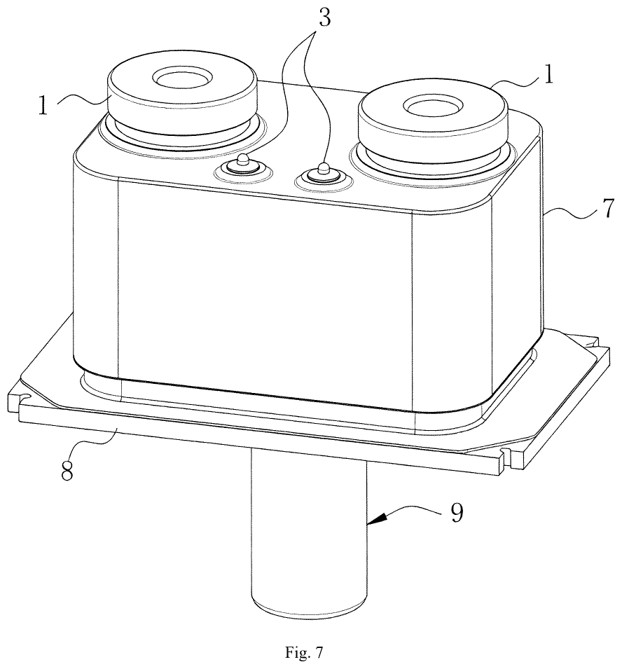

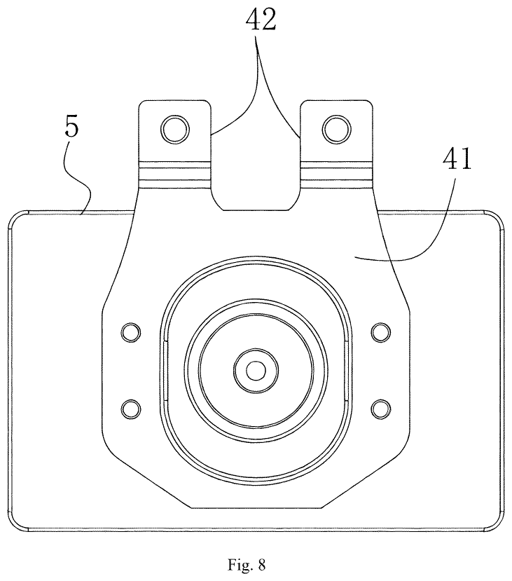

Referring to FIG. 7 and FIG. 8, a difference between this embodiment and Embodiment 1 lies in that: the two auxiliary fixed contacts 3 are distributed on one side of the push rod assembly and are each fixedly disposed along a vertical direction on a top wall of the ceramic cover 7. Correspondingly, the two auxiliary contact legs 42 extend side by side outward from the same side of the insulating base 5 and are positioned one-to-one directly below the two auxiliary fixed contacts 3.

As shown in FIG. 8, the auxiliary movable contact plate 4 is provided with one force arm extension portion 41. The two auxiliary contact legs 42 are both integrally connected to the force arm extension portion 41.

This embodiment adopts this structural design, similarly enabling the force arm of the auxiliary movable contact plate 4 to be not limited only to the portion outside the insulating base 5, but also to include the portion located at the bottom of the insulating base 5, i.e. the force arm extension portion 41. Within limited internal space of the relay, this structure rationally utilizes space at the bottom of the insulating base 5, maximizing the force arm length of the auxiliary movable contact plate 4. This effectively resolves risks of material yielding or fracture caused by short force arms during operation that may result in non-conduction after auxiliary contact closure, thereby guaranteeing normal operation of the relay.

In the foregoing description, numerous specific details are set forth to provide a thorough understanding of the present disclosure. However, the foregoing description is merely a preferred embodiment of the present disclosure. The present disclosure can be implemented in many other ways different from those described herein. Therefore, the present disclosure is not limited by the specific implementations disclosed above. Meanwhile, without departing from the scope of the technical solution of the present disclosure, any person skilled in the art may utilize the methods and technical content disclosed above to make many possible modifications and refinements to the technical solution of the present disclosure, or modify the technical solution into equivalent embodiments. Any simple modification, equivalent change, or refinement made to the above embodiments based on the technical essence of the present disclosure without departing from the content of the technical solution of the present disclosure shall still fall within the scope of protection of the technical solution of the present disclosure.

What is claimed is:

1. A Direct Current (DC) relay with an auxiliary contact, comprising a fixed contact, a movable contact plate, an auxiliary fixed contact, an auxiliary movable contact plate and a pushing rod assembly; wherein
the pushing rod assembly is configured to drive the movable contact plate to make or break contact with the fixed contact, and simultaneously drive the auxiliary movable contact plate to make or break contact with the auxiliary fixed contact;
the pushing rod assembly comprises an insulating base, the auxiliary movable contact plate is fixedly disposed at a bottom of the insulating base, and the auxiliary movable contact plate is provided with a force arm extension portion located at the bottom of the insulating base and an auxiliary contact leg extending outward from the insulating base and arranged opposite to the auxiliary fixed contact; and
the force arm extension portion and the auxiliary contact leg are integrally connected to form an auxiliary movable contact arm.

2. The DC relay with the auxiliary contact according to claim 1, wherein an end of the force arm extension portion away from the auxiliary contact leg is fixedly connected to the insulating base to form a fixed point; the auxiliary contact leg is provided with a contact point configured to abut against the auxiliary fixed contact; and the force arm length of the auxiliary movable contact arm is a vertical distance from the contact point to the fixed point.

3. The DC relay with the auxiliary contact according to claim 1, wherein the auxiliary movable contact plate is made of an elastic conductive metal material; and when the movable contact plate makes contact with the fixed contact, the auxiliary fixed contact abuts against the auxiliary contact leg such that the auxiliary movable contact arm undergoes elastic deformation.

4. The DC relay with the auxiliary contact according to claim 2, wherein two auxiliary contact legs are provided, and the two auxiliary contact legs extend symmetrically outward from opposite sides of the insulating base.

5. The DC relay with the auxiliary contact according to claim 4, wherein the bottom of the insulating base is provided with a support boss; a central portion of the auxiliary movable contact plate is provided with a hole configured to sleeve onto the support boss, forming two force arm extension portions arranged in a herringbone shape and symmetrically distributed; each of the two force arm extension portions is connected to a respective one of the two auxiliary contact legs; and each of the force arm extension portions comprises two ends away from the respective one of the auxiliary contact legs, and each end is provided with a fixed point.

6. The DC relay with the auxiliary contact according to claim 1, wherein two auxiliary contact legs are provided, and the two auxiliary contact legs extend outward from the same side of the insulating base side by side.

7. The DC relay with the auxiliary contact according to claim 2, wherein the insulating base is integrally formed by injection molding of a plastic material; and the insulating base and the force arm extension portion are directly and fixedly connected at the fixed point by any one of riveting, bonding, screw fastening and insert molding.

8. The DC relay with the auxiliary contact according to claim 2, wherein the insulating base is integrally formed by injection molding of a plastic material; a heat staking post is further integrally formed on the bottom of the insulating base; one end of the force arm extension portion is provided with an insertion hole; and the heat staking post is inserted into the insertion hole and fixed via a heat staking riveting process to form the fixed point.

9. The DC relay with the auxiliary contact according to claim 1, wherein one end of the auxiliary contact leg is provided with a horizontally distributed contact tongue; and another end of the auxiliary contact leg is bent downward relative to the contact tongue and connected to the force arm extension portion, such that the contact tongue is at a height greater than the force arm extension portion.
